(19) United States
(12) Patent Application Publication
(10) Pub. No.: US 2025/0291064 A1
(43) Pub. Date: Sep. 18, 2025

(54) GNSS SIGNAL ACQUISITION USING A DIFFERENTIAL COMBINING SCHEME

(71) Applicant: Samsung Electronics Co., Ltd., Suwon-si (KR)

(72) Inventors: Ali Montazeri, San Jose, CA (US); Raghavanachary Sudhakar, Round Rock, TX (US); Ali Jafarnia Jahromi, San Jose, CA (US)

(21) Appl. No.: 18/933,192

(22) Filed: Oct. 31, 2024

Related U.S. Application Data
(60) Provisional application No. 63/566,812, filed on Mar. 18, 2024.

(51) Int. Cl. G01S 19/29; G01S 19/30

(52) U.S. Cl. CPC G01S 19/29; G01S 19/30

(57) ABSTRACT

A method of satellite signal acquisition includes generating a pilot correlation output based on a pilot signal of a received signal from the satellite; generating a data correlation output based on a data signal of the received signal from the satellite; integrating the pilot correlation output to generate an integrated pilot output; integrating the data correlation output to generate an integrated data output; differential combining of the integrated pilot output; differential combining of the integrated data output; summing and applying a coherent integrator to generate an output signal; determining a phase of the output signal; and determining a Doppler of the output signal.

### CROSS-REFERENCE TO RELATED APPLICATION(S)

The present application claims priority to and the benefit of U.S. Provisional Application No. 63/566,812 filed Mar. 18, 2024, the entire content of which is incorporated herein by reference.

### BACKGROUND

### 1. Field

The present disclosure relates to global navigation satellite system (GNSS) signal acquisition.

### 2. Description of the Related Art

Global navigation satellite system (GNSS) is a constellation of satellites that provide signals from space that transmit positioning and timing data to GNSS receivers, which then utilize this data to determine location. Civilian GPS signals have been designed to cater to the stringent demands of safety-critical transportation and other high-performance applications, but acquiring the signal directly poses a challenge due to its abundance of information and the limited processing capabilities of related art receivers. During the signal acquisition phase, the main parameters of the available satellites are identified, including searching the pseudo-random noise sequence (PRN) number associated with each visible satellite and estimating the corresponding Doppler frequency and code delay offsets. Accordingly, GNSS signal acquisition requires extensive search in code, Doppler frequency, and time offset domains.

Several related art methods exist for performing direct acquisition, but these related art signal acquisition methods are computationally complex and therefore require relatively high power consumption.

The above information disclosed in this Background section is only for enhancement of understanding of the background of the invention and therefore it may contain information that does not constitute prior art.

### SUMMARY

The present disclosure relates to various embodiments of a method of acquiring a signal from a satellite in the global navigation satellite system (GNSS). In one embodiment, the method includes generating a pilot correlation output based on a pilot signal of a received signal from a satellite; generating a data correlation output based on a data signal of the received signal from the satellite; integrating, with an integration length, the pilot correlation output to generate an integrated pilot output; integrating, with the integration length, the data correlation output to generate an integrated data output; differential combining of the integrated pilot output; differential combining of the integrated data output; summing and applying coherent integrator (Accumulator) to the integrated pilot output and the integrated data output to generate an output signal; determining a phase of the output signal; and determining a Doppler frequency of the signal. The method may be a single-span method.

Differential combining of the integrated pilot output may utilize intermediate data of the integrated pilot output.

Differential combining of the integrated data output may utilize intermediate data of the integrated data output.

Determining the phase may include performing a search of a curve of the output signal.

Determining the Doppler frequency may utilize an angle estimator.

The received signal from the satellite may be an L1 or L5 GPS signal specification.

The integration length may be a design parameter. For example, the single-span method may perform far fewer multiplications than a non-coherent summation method utilizing a fast Fourier transform in which the number of points of the FFT (i.e., the individual data samples within the signal that are being analyzed) is greater than the integration length (N).

In one embodiment, the method includes generating a correlation output based on a received signal from the satellite; performing a number of segment differential correlation with different values for N; summing absolute values of the outputs to generate an output signal; estimating the phase of the output signal; and estimating the Doppler of the output signal. The method may be a multi-span method.

Each path may have a different integration length.

The method may also include normalizing the integrated outputs prior to summing the absolute values of the integrated outputs.

Determining the phase may include performing a search of a curve of the output signal.

Determining the Doppler frequency may utilize an angle estimator.

The received signal from the satellite may be an L1 or L5 GPS signal specification.

The present disclosure also relates to various embodiments of a GPS receiver. In one embodiment, the GPS receiver includes an antenna, a power supply, and a receiver-processing unit including a processor and a non-volatile memory device connected to the processor. The non-volatile memory device includes instructions which, when executed by the processor, cause the GPS receiver to acquire a signal from a satellite utilizing single-span operations (described below with reference to FIG. 1) or multi-span operations (described below with reference to FIG. 4).

The instructions, when executed by the processor, may cause the GPS receiver to: generate a pilot correlation output based on a pilot signal of the received signal from a satellite; generate a data correlation output based on a data signal of the received signal from the satellite; integrate the pilot correlation output to generate an integrated pilot output; integrate the data correlation output to generate an integrated data output; differential combining of the integrated pilot output; differential combining of the integrated data output; sum and coherently combine the integrated pilot output and the integrated data output to generate an output signal; determine the phase of the output signal; and determine the Doppler frequency of the output signal.

The instructions, when executed by the processor, may cause the GPS receiver to: generate a correlation output based on a received signal from the satellite; perform a number of coherent integrations of the correlation output to generate a number of integrated outputs; sum absolute values of the integrated outputs to generate an output signal; determine a phase of the output signal; and determine a Doppler frequency of the output signal.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable method or system.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIG. 1 is a block diagram illustrating operations of a single-span method of acquiring a signal from a global navigation satellite system (GNSS) according to one embodiment of the present disclosure;

FIG. 2 depicts a differential combining process utilizing mid-point data according to one embodiment of the present disclosure;

FIG. 3 is a graph depicting the Doppler of received signal vs angle of the peak of the output according to embodiments of the present disclosure;

FIG. 4 is a block diagram illustrating operations of a multi-span method of acquiring a signal from a global navigation satellite system (GNSS) according to one embodiment of the present disclosure; and

FIG. 5 is a schematic diagram of a GPS receiver according to one embodiment of the present disclosure.

### DETAILED DESCRIPTION

The present disclosure relates to various methods of signal acquisition from a satellite in the global navigation satellite system (GNSS). In one or more embodiments, the method utilizes a single-span differential combining acquisition technique that utilizes the signal energy from both pilot and data channels to improve acquisition sensitivity and Doppler frequency estimation accuracy. Additionally, the single-span differential combining acquisition technique of the present disclosure improves hardware utilization of the GPS receiver by reducing computational complexity compared to related art signal acquisition methods. The lower computational complexity of the single-span method results in lower power consumption and/or the capability to acquire a higher number of signals simultaneously using the same computational power. In one or more embodiments, the systems and methods of the present disclosure utilize a multi-span combining scheme, which results in a lower acquisition time (faster signal acquisition), a wider range (span) of Doppler frequency search, greater Doppler estimate accuracy, and a higher probability of detection for a given probability of false alarm, compared to related art methods such coherent plus non-coherent acquisition techniques that use time domain correlation or FFT search. In this manner, the methods of the present disclosure enable a GPS receiver to more accurately (and in some embodiments more quickly) acquire a signal from the GNSS satellite.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

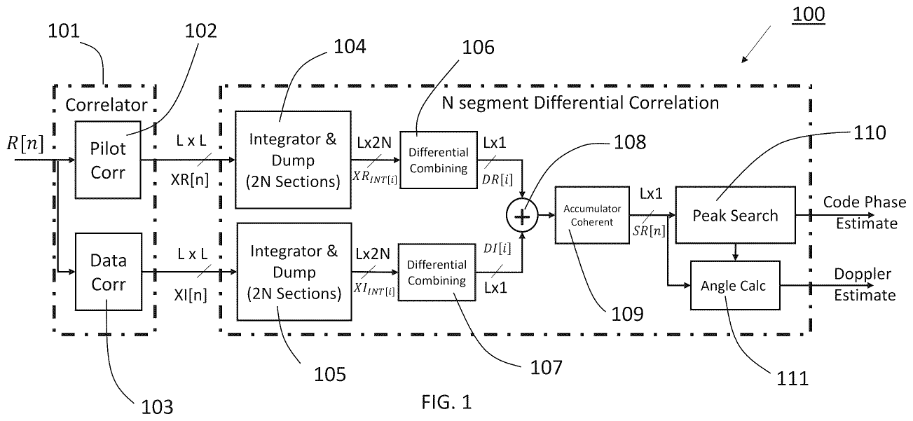

With reference now to FIG. 1, a single-span method 100 of GNSS signal acquisition according to one embodiment of the present disclosure includes a correlator block 101 configured to receive as input the received signal R[n] from a satellite in the GNSS. The received signal R[n] from the satellite may be an L1 or L5 GPS signal specification or other modern GPS signal specification. Satellites are configured to transmit pseudo-random noise (PRN) code C[m] that includes both a pilot signal and a data signal, which is defined according to Equation 1 as follows:

$$C [ m ] = {c}_{i} [ m ] + j {c}_{q} [ m ] \qquad ( Equation 1 )$$

where cᵢ[m] is the data PRN at time index m, c_{q}[m] is the pilot PRN at time index m, and j is square root of −1.

The received signal R[n] from the satellite is defined according to Equation 2 as follows:

$$R [ n ] = ( {c}_{i} [ n ] + j {c}_{q} [ n ] ) {e}^{j ( {w}_{0} n + ϕ )} = {c}_{i} [ n ] cos ( {w}_{0} n + ϕ ) - {c}_{q} [ n ] sin ( {w}_{0} n + ϕ ) + j [ {c}_{q} [ n ] cos ( {w}_{0} n + ϕ ) + {c}_{i} sin ( {w}_{0} n + ϕ ) ] , \qquad ( Equation 2 )$$

where w₀ is the Doppler frequency, ϕ is the phase of the Doppler, n is a time index. In Equation 2 above, the received signal R[n] from the satellite is the PRN code C[m] transmitted from the satellite with Doppler (the term e^{j(w}^{₀}^{n+ϕ)} in Equation 2) and without noise.

In the illustrated embodiment, the correlator 101 includes a pilot correlator operation 102 and a data correlator operation 103. The pilot correlator operation 102 is configured to correlate the pilot signal of the received signal R[n] and the data correlator operation 103 is configured to correlate the data signal of the received signal R[n]. In various embodiments, the pilot correlator operation 102 is configured to output a correlation signal XR[n] defined according to Equation 3 as follows (shift and multiply):

$$XR [ n ] = R [ n ] \cdot {c}_{i} [ n ] \qquad ( Equation 3 )$$

where cᵢ[n] is the data PRN at time index n and R[n] is the received signal from the satellite. In various embodiments, the data correlator 103 is configured to output a correlation signal XI[n] defined according to Equation 4 as follows:

$$XR [ n ] = R [ n ] \cdot {c}_{q} [ n ] \qquad ( Equation 4 )$$

where c_{q}[n] is the pilot PRN (imaginary) at time index n and R[n] is the received signal from the satellite. In one or more embodiments in which there is code and signal alignment (i.e., n==m), the correlation signal XR[n] output by the pilot correlator operation 102 is defined according to Equation 5 as follows:

$$XR [ n ] = cos ( {w}_{0} n + ϕ ) - {c}_{i} [ n ] {c}_{q} [ n ] sin ( {w}_{0} n + ϕ ) + j [ {c}_{q} [ n ] {c}_{i} [ n ] cos ( {w}_{0} n + ϕ ) + sin ( {w}_{0} n + ϕ ) ] \qquad ( Equation 5 )$$

Additionally, in one or more embodiments in which there is code and signal alignment (i.e., n==m), the correlation signal XI[n] output by the data correlator operation 103 is defined according to Equation 6 as follows:

$$XI [ n ] = {c}_{i} [ n ] {c}_{q} [ n ] cos ( {w}_{0} n + ϕ ) - sin ( {w}_{0} n + ϕ ) + j [ cos ( {w}_{0} n + ϕ ) + {c}_{i} [ n ] {c}_{q} [ n ] sin ( {w}_{0} n + ϕ ) ] \qquad ( Equation 6 )$$

In the illustrated embodiment, the method 100 also includes a first integrator and dump operation 104 configured to receive the correlation signal XR[n] output by the pilot correlator operation 103 and a second integrator and dump operation 105 configured to receive the correlation signal XI[n] output by the data correlator operation 103. The first integrator and dump operation 104 is configured to receive the correlation signal XR[n] output by the pilot correlator 102 and to output an integration signal XR_INT defined according to Equation 7 as follows:

$${XR}_{INT} [ i ] = {XR}_{{INT}_{init}} [ i ] + {XR}_{{INT}_{mid}} [ i ] ; i = 1 , … , 2 N - 1 \qquad ( Equation 7 )$$

$$where$$

$${XR}_{{INT}_{init}} [ i ] = {\sum }_{n = 1 + \frac{( i - 1 ) L}{N}}^{i . ( L / N )} XR [ n ] \approx {α}_{0} . cos ( {w}_{0} i + ϕ ) + j {α}_{0} . sin ( {w}_{0} i + ϕ ) = {α}_{0} . {e}^{j ( {w}_{0} i + ϕ )} ; i = N + 1 , … , N - 1$$

$${XR}_{{INT}_{mid}} [ i ] = {\sum }_{n = 1 + \frac{( i - 1 ) L}{N}}^{i . ( L / N )} XR [ n ] \approx {α}_{1} . cos ( {w}_{0} i + ϕ ) + j {α}_{1} . sin ( {w}_{0} i + ϕ ) = {α}_{1} . {e}^{j ( {w}_{0} i + ϕ )} ; i = N + 1 , … , 2 N - 1$$

where L is the code length, N is the integration length, w₀ is the Doppler frequency, ϕ is the phase of the Doppler,

$$δ = \frac{L}{2 N}$$

and α₀ and α₁ are scalars. Accordingly, the integration signal XR_INT output by the first integrator and dump operation 104 is the sum of the correlation signals XR[n] output by the pilot correlator operation 102 over 2N sections or segments. The second integrator and dump operation 105 is configured to receive the correlation signal XI[n] output by the data correlator operation 103 and to output an integration signal XI_INT[i] according to Equations 8 and 9 as follows:

$${XI}_{INT} [ i ] = {XI}_{{INT}_{init}} [ i ] + {XI}_{{INT}_{mid}} [ i ] ; i = 1 , … , 2 N - 1 \qquad ( Equation 8 )$$

$$where$$

$${XI}_{{INT}_{mid}} [ i ] = {\sum }_{n = 1 + \frac{( i - 1 ) L}{N}}^{i . ( L / N )} XI [ n ] \approx - {α}_{0} . sin ( {w}_{0} i + ϕ ) + j {α}_{0} . cos ( {w}_{0} i + ϕ ) ; i = 1 , … , N$$

$${XI}_{{INT}_{mid}} [ i ] = {\sum }_{n = 1 + \frac{( i - 1 - N ) L}{N} + δ}^{i . ( \frac{L}{N} ) + δ} XI [ n ] \approx - {α}_{1} . sin ( {w}_{0} i + ϕ ) + j {α}_{1} . cos ( {w}_{0} i + ϕ ) ; i = N + 1 , … , 2 N - 1$$

$${XI}_{{INT}_{f}} [ i ] = 𝒥 \{ {XI}_{INT} [ i ] \} + ℜ \{ {XI}_{INT} [ i ] \} = ( {α}_{0} + {α}_{1} ) . {e}^{j ( {w}_{0} t + ϕ )} ; i = 1 , … , 2 N - 1 \qquad ( Equation 9 )$$

where [symbol] { } is the imaginary part of the integration signal XI_INT[i] and [symbol] { } is the real part of the integration signal XI_INT[i].

In the illustrated embodiment, the method 100 also includes a first differential combining operation 106 configured to receive the integration signal XR_INT output from the first integrator and dump operation 104 and a second differential combining operation 107 configured to receive the integration signal XI_INT[i] output from the second integrator and dump operation 105. The differential combining operation 106 is configured to receive as an input the integration signal XR_INT output from the first integrator and dump operation 104 and to output a signal DR[i] according to Equation 10 as follows:

$$DR [ i ] = {DR}_{init} [ i ] + {DR}_{mid} [ i ] = ( {α}_{0}^{2} + {α}_{1}^{2} ) \cdot {e}^{- {jw}_{0}} ; i = 1 , … , 2 N - 3 \qquad ( Equation 10 )$$

$$where$$

$${DR}_{init} [ i ] = XR\_INT [ i ] . conj ( XR\_INT [ i + 1 ] ) = {α}_{0}^{2} . {e}^{- {jw}_{0}} ; i = 1 , … , N - 1$$

$${DR}_{mid} [ i ] = XR\_INT [ i + 1 ] . conj ( XR\_INT [ i + 2 ] ) = {α}_{1}^{2} . {e}^{- {jw}_{0}} ; i = N , … , 2 N - 3$$

where conj is the complex conjugate operation.

The second differential combining operation 107 is configured to receive as an input the integration signal XI_INT[i] output from the first integrator and dump operation 105 and to output a signal DI[i] according to Equation 11 as follows:

$$DI [ i ] = {DI}_{init} [ i ] + {DI}_{mid} [ i ] = ( {α}_{0}^{2} + {α}_{1}^{2} ) \cdot {e}^{- {jw}_{0}} ; i = 1 , … , 2 N - 3 \qquad ( Equation 11 )$$

$$where$$

$${DI}_{init} [ i ] = {XI}_{{INT}_{f}} [ i ] . conj ( {XI}_{{INT}_{f}} [ i + 1 ] ) = {α}_{0}^{2} . {e}^{- {jw}_{0}} ; i = 1 , … , N - 1$$

$${DI}_{mid} [ i ] = {XI}_{{INT}_{f}} [ i + 1 ] . conj ( {XI}_{{INT}_{f}} [ i + 2 ] ) = {α}_{1}^{2} . {e}^{- {jw}_{0}} ; i = N , … , 2 N - 1$$

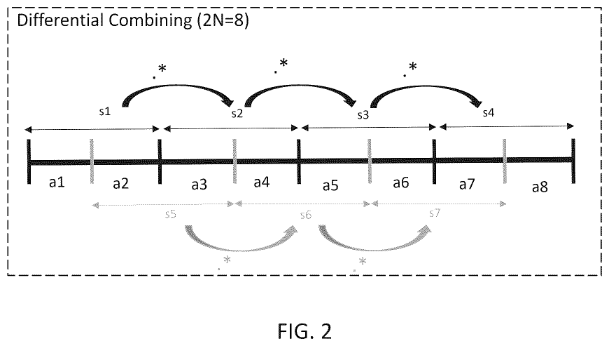

In one or more embodiments, the first differential combining operation 106 and the second differential combining operation 107 may utilize an intermediate data point (e.g., a mid-point data) of each span s, which is configured to improve convergence time and Doppler estimation accuracy (e.g., utilizing an intermediate data point increases the SNR by 2 dB). As illustrated in FIG. 2, in one or more embodiments the first differential combining operation 106 and the second differential combining operation 107 may both perform a single-span combining operation utilizing mid-point data as defined according to Equation 12 as follows:

$$B ( l ) = {s}_{1} ( l ) . {s}_{2}^{*} ( l ) + {s}_{2} ( l ) . {s}_{3}^{*} ( l ) . {s}_{4}^{*} ( l ) + {s}_{5} ( l ) . {s}_{6}^{*} ( l ) + {s}_{6} ( l ) . {s}_{7}^{*} ; where l = 0 , … , L - 1 , and where {s}_{1} ( l ) = {a}_{1} ( l ) + {a}_{2} ( l ) \qquad ( Equation 12 )$$

In one or more embodiments, utilizing the mid-point data of the first integrator and dump operation 104 and the second integrator and dump operation 105 is configured to improve the performance of the single-span method in terms of convergence time and Doppler estimation accuracy. In one or more embodiments, utilizing the mid-point data of the first integrator and dump operation 104 and the second integrator and dump operation 105 may increase the computational complexity of the single-span method, but the complexity may still be lower than the related art matched filter Non-Coherent Summation (NCS)-based method.

In the illustrated embodiment, the method 100 also includes a summing operation 108 and a coherent accumulator operation 109 configured to sum and coherently integrate the signal DR[i] output by the first differential combining operation 106 and the signal DI[i] output by the second differential combining operation 107 according to Equation 12 as follows:

$$SR [ n ] = SR [ n ] + {\sum }_{i = 1}^{2 N - 3} DR [ i ] + DI [ i ] \qquad ( Equation 13 )$$

Coherent integration is an operation that preserves the phase information of the received signal and sums it in the complex domain such that both the amplitude and the phase of the signal are included in the integration process. In contrast, non-coherent integration discards the phase information of the received signals and sums only the magnitude or power of the received signal. Coherently integrating the signals DR[i] and DI[i] is configured to increase the signal-to-noise (SNR) ratio compared to a related art non-coherent summation (NCS) process. In one or more embodiments in which there is code and signal alignment (i.e., n==m) after M iterations of coherent integration according to Equation 13 above, the output SR[n] of the accumulator operation 109 is defined according to Equation 14 as follows:

$$SR [ n ] = 2. M . ( {α}_{0}^{2} + {α}_{1}^{2} ) ( 2 N - 3 ) \cdot {e}^{- {jw}_{0}} \qquad ( Equation 14 )$$

where M is the integration time and N is the integrator parameter. In general, a higher integration time M results in a more accurate estimation of the Doppler frequency w₀.

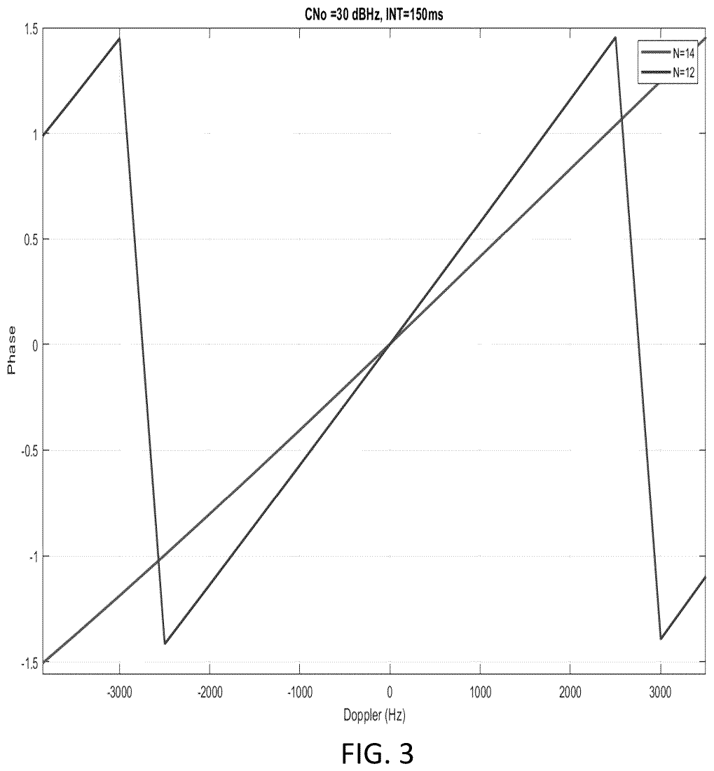

FIG. 3 is a graph depicting the phase (angle) of SR[n] of the accumulator operation 109 as a function of Doppler (Hz) and Phase ϕ according to two embodiments of the present disclosure in which the integrator parameter N is 12 and in which the integrator parameter N is 14.

In the illustrated embodiment, the single-span method 100 also includes an operation 110 of estimating the code phase ϕ of the output signal SR[n] of the accumulator operation 109. The operation 110 is a peak search configured to find the peak (or approximately the peak) of SR[n].

In one or more embodiments, the single-span method 100 includes an operation 111 of estimating the Doppler frequency w₀ of the output signal SR[n] of the accumulator operation 109. The operation 111 of estimating the Doppler frequency w₀ of the output signal SR[n]. The tasks of the single-span method 100 described above may be performed by a GPS receiver or any GNSS receiver to perform satellite acquisition.

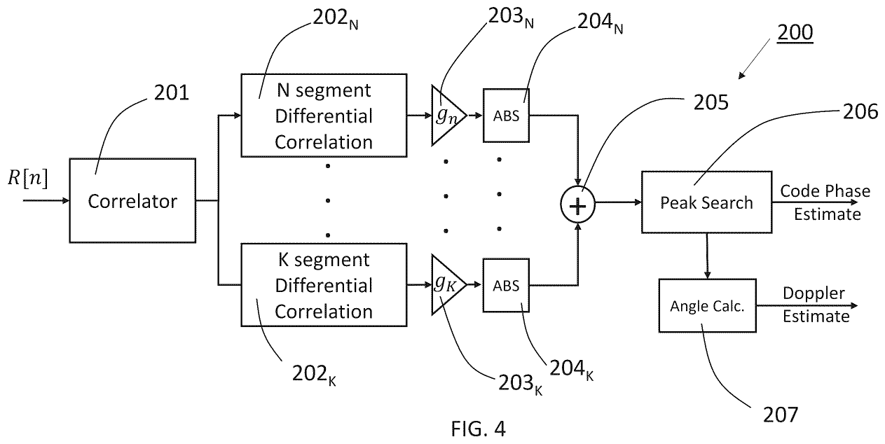

FIG. 4 depicts a multi-span method 200 of GNSS signal acquisition according to one embodiment of the present disclosure. In one or more embodiments, the multi-span method 200 is configured to increase signal-to-noise ratio, reduce convergence time, and address a wider Doppler range than the embodiment of the single-span method 100 described above with reference to FIG. 1. In the illustrated embodiment, the multi-span method 200 includes a correlation operation 201 configured to receive the received signal R[n] from a satellite in the GNSS and to output a correlation signal.

In the illustrated embodiment, the multi-span method 200 also includes performing a plurality of coherent differential integration operations 202 (e.g., 202ₙ . . . 202ₖ) on the signal output from the correlator operation 201. In one or more embodiments, each of the differential integration operations 202 has a different integration length N (e.g., the multi-span method 200 utilizes L single-span combining paths (L-order) with different integration lengths (different N)). For instance, in the illustrated embodiment, the multi-span method 200 includes an n-th differential integration operation 202ₙ having an N-segment integration length and a k-th differential integration operation 202ₖ having a K-segment integration length. The output of each integrator operation 202 independently adds up using coherent integration.

In the illustrated embodiment, the multi-span method 200 also includes a plurality of amplifier operations 203 configured to receive the outputs of the plurality of differential integration operations 202 (e.g., amplifier operations 203n . . . 203k configured to receive the outputs of the correlator operations 202ₙ . . . 202ₖ respectively). The amplifier operations 203 are configured to output gain signals g from the outputs of the plurality of differential integration operations 202 (e.g., the amplifier operations 203 are configured to output gain signals gn . . . gk from the outputs of the correlator operations 202ₙ . . . 202ₖ respectively).

In the illustrated embodiment, the multi-span method 200 also includes a plurality of absolute value operations 204 (e.g., absolute value operations 204ₙ . . . 204ₖ) configured to calculate or determine the absolute values of the gain signals g (gain signals gn . . . gk) output from the plurality of amplifier operations 203.

In the illustrated embodiment, the multi-span method 200 also includes a summing operation 205 configured to sum the absolute values output by the absolute value operations 204.

In the illustrated embodiment, the multi-span method 200 also includes an operation 206 of estimating the peak of the output signal from the summing operation 205.

In one or more embodiments, the multi-span method 200 includes an operation 207 of estimating the Doppler frequency w₀ of the output signal from the summing operation 206. The operation 207 of estimating the Doppler frequency w₀ of the output signal may utilize an angle estimator. The tasks of the multi-span method 200 described above may be performed by a GPS receiver or any GNSS receiver to perform satellite acquisition

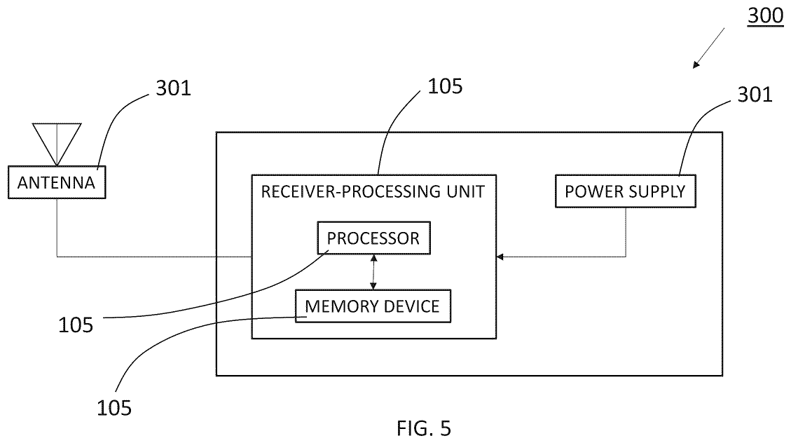

The methods 100, 200 described above may be performed by a GPS receiver. FIG. 5 is a schematic diagram of a GPS receiver 300 according to one embodiment of the present disclosure. In the illustrated embodiment, the GPS receiver 300 includes an antenna 301 to receive a signal from a GNSS satellite, a receiver-processing unit 302 including a processor 303 and a non-volatile memory device 304, and a power supply 305 connected to the receiver-processing unit 302. The non-volatile memory device 304 includes computer-readable instructions (i.e., software code) which, when executed by the processor 303, cause the GPS receiver 300 to perform the operations of the single-span acquisition method 100 and/or the multi-span acquisition method 200 described above.

The methods of GNSS signal acquisition of the present disclosure, and the GPS receiver executing these methods, are configured to result in lower computational complexity than a related art non-coherent summation (NCS) method that utilizes time domain correlation or FFT search. For instance, in an embodiment in which the integration length N is 4 and the related art method utilized 8 points fast Fourier transform (FFT), the methods of the present disclosure result in significant reduction in the number of processing operations, which results in faster signal acquisition and/or signal acquisition with less power consumption compared to related art systems and methods of GNSS signal acquisition. Moreover, unlike the related art NCS methods, the methods of the present disclosure do not require auto-scaling for the fixed-point implementation, which results in a less complex signal acquisition process. Additionally, the methods of GNSS signal acquisition of the present disclosure result in higher Doppler frequency estimation accuracy compared to the related art NCS method.

Embodiments of the subject matter and the operations described in this specification may be implemented in analog or digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of satellite signal acquisition, the method comprising:
generating a pilot correlation output based on a pilot signal of a received signal from a satellite, and a data correlation output based on a data signal of the received signal from the satellite;
modifying, with an integration length, the pilot correlation output to generate an integrated pilot output, and the data correlation output to generate an integrated data output;
differentially combining the integrated pilot output;
differentially combining the integrated data output; and
applying a coherent integrator to the integrated pilot output and the integrated data output to generate an output signal.

2. The method of claim 1, further comprising:
determining a phase of the output signal; and
determining a Doppler frequency of the output signal.

3. The method of claim 2, further comprising:
establishing a connection to the satellite based on the phase of the output signal and the Doppler frequency of the output signal.

4. The method of claim 1, wherein the received signal comprises a pilot pseudo-random noise sequence.

5. The method of claim 1, wherein the differential combining of the integrated pilot output further comprises utilizing intermediate data of the integrated pilot output.

6. The method of claim 5, wherein the differential combining of the integrated data output further comprises utilizing intermediate data of the integrated data output.

7. The method of claim 1, wherein the determining the phase comprises performing a search of a curve of the output signal.

8. The method of claim 1, wherein the determining the Doppler frequency comprises utilizing an angle estimator.

9. The method of claim 1, wherein the received signal from the satellite is an L1 or L5 GPS signal specification.

10. A multi-span method of satellite signal acquisition, the method comprising:
generating a correlation output based on a received signal from a satellite;
performing a plurality of segment differential correlations with different code lengths;
generating an output signal based on a combination of absolute values of outputs from the plurality of segment differential correlations;
determining a phase of the output signal; and
determining a Doppler frequency of the output signal.

11. The method of claim 10, further comprising:
establishing a connection to the satellite based on the phase of the output signal and the Doppler frequency of the output signal.

12. The method of claim 10, wherein each of the plurality of segment differential correlations has a different integration length.

13. The method of claim 10, further comprising normalizing the integrated outputs prior to performing the combination of the absolute values of the integrated outputs.

14. The method of claim 10, wherein the determining the phase comprises performing a search of a curve of the output signal.

15. The method of claim 14, wherein the determining the Doppler frequency comprises utilizing an angle estimator.

16. The method of claim 10, wherein the received signal from the satellite is an L1 or L5 GPS signal specification.

17. A GPS receiver comprising:
an antenna;
a power supply; and
a receiver-processing unit comprising a processor and a non-volatile memory device connected to the processor,
wherein the non-volatile memory device includes instructions which, when executed by the processor, cause the GPS receiver to:
generate a pilot correlation output based on a pilot signal of a received signal from a satellite;
generate a data correlation output based on a data signal of the received signal from the satellite;
integrate the pilot correlation output to generate an integrated pilot output;
integrate the data correlation output to generate an integrated data output;
perform differential combining of the integrated pilot output;
perform differential combining of the integrated data output;
sum and coherently combine the integrated pilot output and the integrated data output to generate an output signal;
determine a phase of the output signal; and
determine a Doppler frequency of the output signal.

18. The GPS receiver of claim 17, wherein:
the differential combining of the integrated pilot output comprises utilizing intermediate data of the integrated pilot output, and
the differential combining of the integrated data output comprises utilizing intermediate data of the integrated data output.

19. The GPS receiver of 18, wherein the instructions, when executed by the processor, cause the GPS receiver to:
establish a connection to the satellite based on the phase of the output signal and the Doppler frequency of the output signal.

20. The GPS receiver of 18, wherein the determining the Doppler frequency comprises utilizing an angle estimator.
